(19) United States
(12) Patent Application Publication
(10) Pub. No.: US 2014/0041453 A1
(43) Pub. Date: Feb. 13, 2014

(54) INERTIAL SENSING DEVICE

(71) Applicants: Jux WIN, Jebei City (TW); Wei-Leun FANG, Hsinchu City (TW)

(72) Inventors: Jux WIN, Jebei City (TW); Wei-Leun FANG, Hsinchu City (TW)

(21) Appl. No.: 13/610,491

(22) Filed: Sep. 11, 2012

(30) Foreign Application Priority Data
Aug. 7, 2012 (TW) 101128377

(51) Int. Cl. G01P 15/02

(52) U.S. Cl. 73/514.38

(57) ABSTRACT

An inertial sensing device is provided. The inertial device includes a mass proof, a sensing electrode layer to sense the motion of the mass proof, and a spring coupled and to support the mass proof. Wherein, the single-material mass proof can perform multi degree-of freedom inertial sensing.

### TECHNICAL FIELD

The present invention relates to a sensing device, more especially an inertial sensing device.

### BACKGROUND

Size of the conventional sensing device which has a single-material-oriented mass proof is large and the single-material-oriented mass proof is not easy to integrate the processing circuits for a system-on-a-chip (SoC). And, the single mass proof corresponds to a single axis output, thus the capacitive sensing electrode just can sensing the limited and fixed degree-of-freedom by co-operating with the mass proof to sense the variance of the capacitor. The specification of the single mass proof is fixed and can not be modulated during the design stage or during the fabrication process. Moreover, in order to achieve the goal of integrating the single mass proof and the processing circuit for a SoC system, an extra and non-standard process is necessary to fulfill in the standard semiconductor technologies process. As a result, the cost may be increased. However, the complex-material-oriented mass proof can not avoid the disadvantage of the inaccurate issue which caused from the deformation comes from the mechanical or thermal stress.

### SUMMARY

One of the purposes of the invention is to disclose an inertial sensing device includes a mass proof, a sensing electrode layer to sense the motion of the mass proof, and a spring coupled and to support the mass proof. Wherein, the single-material mass proof can perform multi degree-of freedom inertial sensing.

One of the purposes of the invention is to disclose an inertial sensing matrix includes a plurality of inertial sensing devices, each of the inertial sensing devices includes a mass proof, a sensing electrode layer to sense the motion of the mass proof, and a spring coupled and to support the mass proof. Wherein, the single-material mass proof can perform multi degree-of freedom inertial sensing. The plurality of inertial sensing devices is arranged as a matrix, so as the performance and the specification of the inertial sensing matrix can be linear adjusted by adjusting the amount of the inertial sensing device of the inertial sensing matrix.

In one embodiment, the inertial sensing device of the invention prevents any deformation comes from the mechanical or thermal stress, and multi-electrode design makes this structure achieve multi degree-of-freedom inertial sensing.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates an inertial sensing device in accordance with one embodiment of the present invention.

FIG. 2 illustrates a side view and a bottom side view of an inertial sensing device in accordance with one embodiment of the present invention.

FIG. 3 illustrates an inertial sensing device in accordance with another embodiment of the present invention.

FIG. 4 illustrates a bottom side view of a bottom layer of an inertial sensing device of FIG. 3 in accordance with one embodiment of the present invention.

FIG. 5 illustrates an inertial sensing matrix in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

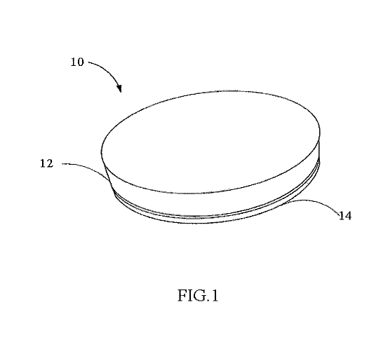

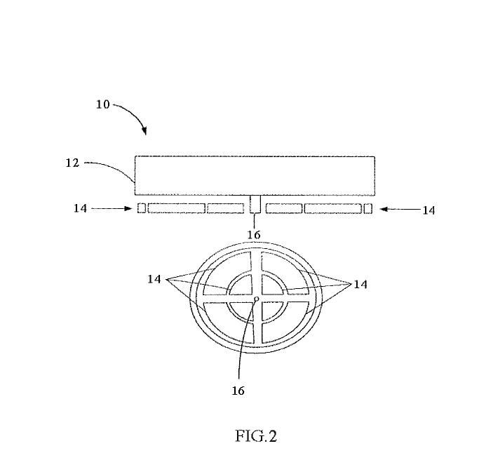

FIG. 1 illustrates an inertial sensing device in accordance with one embodiment of the present invention. The inertial sensing device 10 includes a mass proof 12, a sensing electrode layer 14, and a spring (shown in FIG. 2) coupled to the mass proof 12. The sensing electrode layer 14 sensing the motion of the mass proof 12 (such as the out-of-plane motion) and the sensing electrode layer 14 generates a capacitive variation therefore to calculate the direction and the amplitude of the interaction forces. As a result, the inertial sensing device 10 can achieve the goal of inertial sensing.

Please refer to FIG. 2 with FIG. 1. FIG. 2 illustrates a side view and a bottom side view of an inertial sensing device in accordance with one embodiment of the present invention. In one embodiment, the inertial sensing device 10 has a spring 16 coupled to the mass proof 12, wherein the bottom metal of the inertial sensing device 10 can be acted as a support and allows the mass proof 12 to rotate at any angle.

The sensing electrode layer 14 can be flexibly design patterns for 4 electrodes or more, the amount of the electrode is not limited. In one embodiment, the sensing electrode layer 14 can be configured underneath the mass proof 12 and sensing the out-of-plane motion by using the metal part of the inertial sensing device 10. The electrode of the sensing electrode layer 14 can perform the function of the actuating, capacitive sensing, and DC-tuning or calibration.

In one embodiment, in operation, the electrode(s) of the sensing electrode layer 14 generates a differential capacitive variation when the mass proof 12 of the inertial sensing device 10 motions. So as the inertial sensing device 10 can calculates the direction and the amplitude of the interaction force and sense the degree-of-freedom.

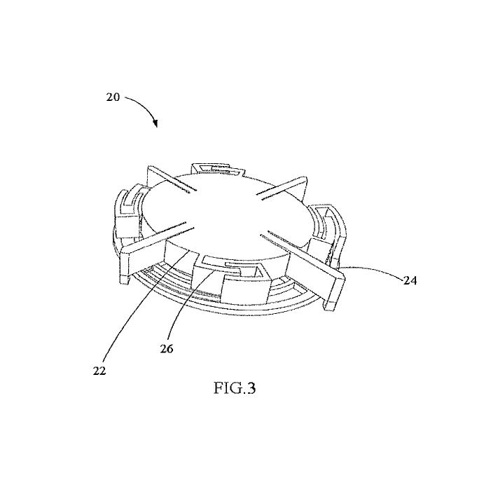

FIG. 3 illustrates an inertial sensing device in accordance with another embodiment of the present invention. The inertial sensing device 20 includes a mass proof 22, a sensing electrode layer 26, and a spring 24 coupled to the mass proof 22. The sensing electrode layer 26 senses the motion (such as the in-plan motion) of the mass proof 22 and calculates the direction and the amplitude of the interaction force, so as to achieve the goal of inertial sensing.

In one embodiment, the spring 24 is a metal with thin structure and configured beside the mass proof 22. And, the sensing electrode layer 26 is configured beside the mass proof 22 to couple the mass proof 22 for sensing the in-plane motion.

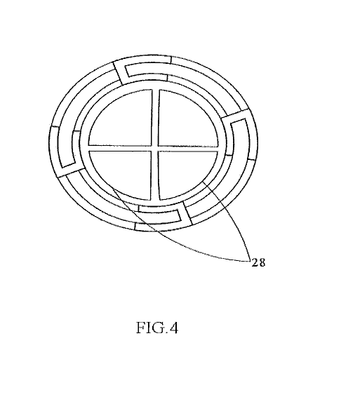

In one embodiment, the inertial sensing device 20 further includes a calibration electrode 28 (shown in FIG. 4). The calibration electrode28 which underneath the sensing electrode layer 26 can perform the in-plane calibration when the mass proof 22, the upper metal structure, sensing the in-plane motion. The calibration electrode 28 can perform the DC-tuning process and calibration process to satisfy the precision requirement of the gyroscope for frequency matching.

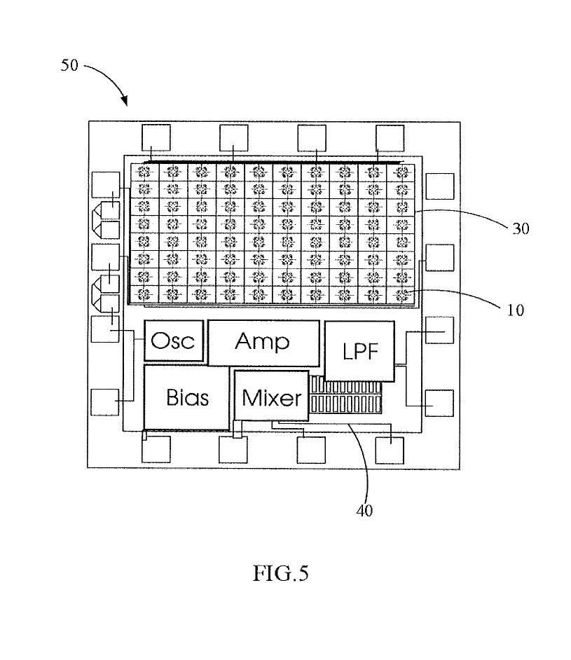

FIG. 5 illustrates an inertial sensing matrix in accordance with one embodiment of the present invention. Please refer to FIG. 1 at the same time. An inertial sensing matrix 30 and a circuit 40 are integrated in a system-on-a-chip 50. The acreages and the volumes of the mass proof 12, the sensing electrode layer 14, and the spring 16 of a single inertial sensing device 10 can be adjusted to meet the desire specification requirement of the user. And the size of the inertial sensing matrix 30 can be adjusted by linearly increasing or linearly decreasing the amount of the inertial sensing device 10 of the inertial sensing matrix 30. The inertial sensing matrix 30 and the circuit 40 can be easily fabricated in the standard semiconductor technologies at the same time, and the inertial sensing matrix 30 and the circuit 40 can be integrated as a system-on-a-chip 50.

Accordingly, the present invention provides inertial sensing devices with single material (such as, metal). The metal of the bottom part of the inertial sensing device is acted as a sensing electrode layer, and the body of the inertial sensing is thick enough to act as a mass proof. The bottom of the inertial sensing device includes a spring (such as, metal) operable for supporting the inertial sensing device. And, the sensing electrode layer which is configured underneath the inertial sensing device can be flexibly design patterns for out-of-plane sensing and in-plane sensing. Moreover, the present invention provides an inertial sensing matrix with a plurality of inertial sensing devices. The performance and the specification of the inertial sensing matrix can be linearly adjusted by adjusting the amount of the inertial sensing device of the inertial sensing matrix. The present invention can be easily fulfilled in the standard semiconductor technologies to integrate the processing circuits for a system-on-a-chip (SoC). As such, the present invention effectively increases the design flexibility of inertial sensing devices, lower the manufacturing cost, and the adoption for more kinds of sensing products.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. An inertial sensing device, comprising:
a mass proof;
a sensing electrode layer operable for sensing a motion of said mass proof; and
a spring coupled to said mass proof and operable for supporting said mass proof

2. The inertial sensing device as claimed in claim 1, wherein said sensing electrode layer is configured underneath said mass proof

3. The inertial sensing device as claimed in claim 1, wherein said sensing electrode layer is configured beside said mass proof and is coupled to said mass proof.

4. The inertial sensing device as claimed in claim 1, wherein said spring is configured underneath said mass proof

5. The inertial sensing device as claimed in claim 1, wherein said spring is configured beside said mass proof and is coupled to said mass proof

6. The inertial sensing device as claimed in claim 5, wherein said spring includes one or more metals with thin structure.

7. The inertial sensing device as claimed in claim 1, wherein said mass proof is a single-material mass proof.

8. An inertial sensing device, comprising:
a plurality of inertial sensing devices, wherein, each of said plurality of inertial sensing devices comprises:
a mass proof ;
a sensing electrode layer operable for sensing a motion of said mass proof; and
a spring coupled to said mass proof and operable for supporting said mass proof;
wherein, said plurality of inertial sensing devices are arranged as a matrix.
